(19) United States
(12) Patent Application Publication
(10) Pub. No.: US 2022/0266719 A1
(43) Pub. Date: Aug. 25, 2022

(54) VEHICLE MANAGEMENT APPARATUS AND COMPUTER-READABLE MEDIUM

(71) Applicant: Panasonic Intellectual Property Management Co., Ltd., Osaka (JP)

(72) Inventors: Takuma IIDA, KANAGAWA KEN (JP); Takayuki IWASAKI, KANAGAWA KEN (JP); Masaaki HOSHIDA, FUKUOKA KEN (JP)

(73) Assignee: Panasonic Intellectual Property Management Co., Ltd., Osaka (JP)

(21) Appl. No.: 17/742,091

(22) Filed: May 11, 2022

Related U.S. Application Data
(63) Continuation of application No. PCT/JP2020/027569, filed on Jul. 15, 2020.

(30) Foreign Application Priority Data
Nov. 29, 2019 (JP) 2019-217436

(51) Int. Cl. B60L 58/16; G07C 5/04; G06Q 50/30

(52) U.S. Cl. CPC B60L 58/16; G07C 5/04; G06Q 50/30

(57) ABSTRACT

A vehicle management apparatus according to the present disclosure includes a memory, and a hardware processor coupled to the memory. The hardware processor is configured to: acquire a degradation state of a battery mounted on a vehicle, and an external variable factor concerning a plurality of districts in which the vehicle is to travel; and generate, based on the degradation state of the battery and the external variable factor, a vehicle deployment plan in which assignment of the vehicle to the plurality of districts is defined.

### CROSS-REFERENCE TO RELATED APPLICATIONS

This application is a continuation of International Application No. PCT/JP2020/027569, filed on Jul. 15, 2020 which claims the benefit of priority of the prior Japanese Patent Application No. 2019-217436, filed on Nov. 29, 2019, the entire contents of which are incorporated herein by reference.

### FIELD

The present disclosure relates to a vehicle management apparatus and a computer-readable medium.

### BACKGROUND

Conventionally, a technique for generating an operation plan, of service electric vehicles, that reflects charging times and the locations of charging spots has been known. In a conventional example as described above, it is assumed that the number of electric vehicles that have been deployed is sufficient for implementing relevant service. Related conventional techniques include Japanese Patent No. 6301730.

The present disclosure provides a vehicle management apparatus and a vehicle management program product that enable generation of a highly precise vehicle deployment plan.

### SUMMARY

A vehicle management apparatus according to the present disclosure includes a memory, and a hardware processor coupled to the memory. The hardware processor is configured to: acquire a degradation state of a battery mounted on a vehicle, and an external variable factor concerning a plurality of districts in which the vehicle is to travel; and generate, based on the degradation state of the battery and the external variable factor, a vehicle deployment plan in which assignment of the vehicle to the plurality of districts is defined.

### BRIEF DESCRIPTION OF THE DRAWINGS

FIG. 1 is a view illustrating an example where a vehicle management apparatus according to an embodiment is applied to a freight company;

FIG. 2 is a view illustrating an example of functions of the vehicle management apparatus according to the embodiment;

FIG. 3 is a view illustrating an example of external variable factors according to the embodiment;

FIG. 4 is a view illustrating an example of the relation between the number of vehicles to be deployed in a district X and the corresponding states of health (SOHs), according to the embodiment;

FIG. 5 is a view illustrating an example of the relation between the number of vehicles to be deployed in a district Y and the corresponding SOHs, according to the embodiment;

FIG. 6 is a flowchart illustrating an example of the procedure of vehicle deployment plan processing that is executed in the vehicle management apparatus according to the embodiment; and

FIG. 7 is a flowchart illustrating an example of the procedure of operation plan processing that is executed in the vehicle management apparatus according to the embodiment.

### DETAILED DESCRIPTION

With reference to the drawings, the following describes an embodiment of a vehicle management apparatus and a vehicle management program according to the present disclosure.

### First Embodiment

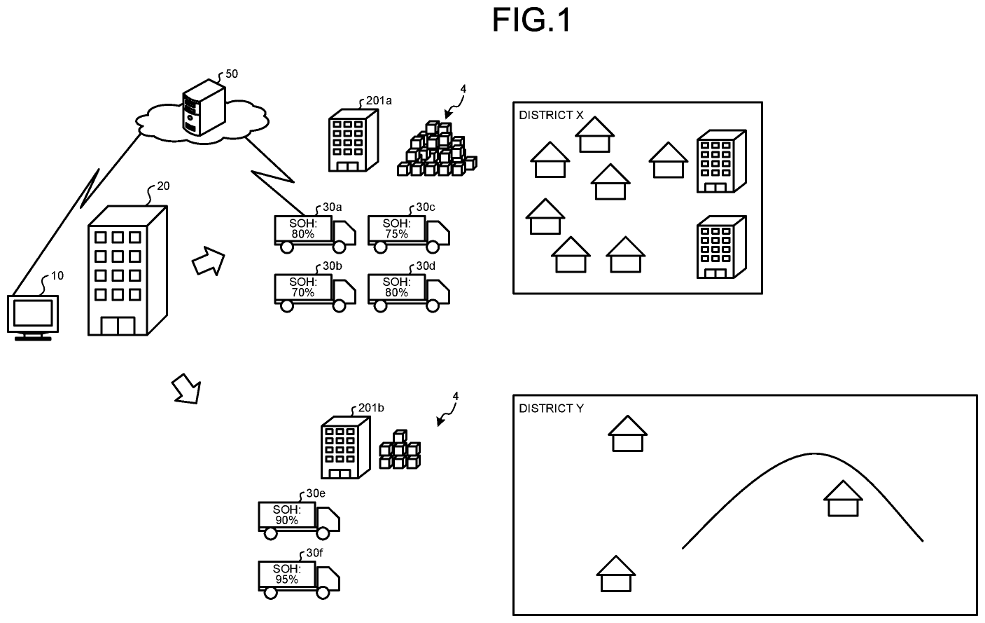

FIG. 1 is a view illustrating an example where a vehicle management apparatus 10 according to a first embodiment is applied to a freight company 20.

As illustrated in FIG. 1, the vehicle management apparatus 10 is a personal computer (PC), a server apparatus, or the like provided in the freight company 20. The vehicle management apparatus 10 includes a control apparatus, a storage apparatus (memory), an external storage device, a display apparatus, and an input apparatus, that is, has a hardware configuration that is available when a typical computer is used. Examples of the control apparatus include a central processing unit (CPU); examples of the storage apparatus include a read only memory (ROM) and a random access memory (RAM); examples of the external storage device include a hard disk drive (HDD) and a compact disc (CD) drive device; examples of the display apparatus include a display device; and examples of the input apparatus include a keyboard and a mouse.

The freight company 20 has delivery vehicles 30a to 30f deployed to a plurality of delivery target districts. For example, the vehicles 30a to 30d have been deployed to a delivery station 201a in a district X in an example illustrated in FIG. 1. The vehicles 30e and 30f have been deployed to a delivery station 201b in a district Y.

The vehicles 30a to 30f are delivery electric vehicles (EVs). The vehicles 30a to 30f are driven by power discharged from a battery such as a rechargeable secondary battery. The type of the battery is not particularly limited, and may be, for example, a lithium-ion battery or a nickel-hydrogen battery. The battery is an example of a battery in the present embodiment.

All of the delivery vehicles are electric vehicles in FIG. 1; however, the delivery vehicles may include a non-electric vehicle such as a gasoline car and may include a hybrid vehicle. The number of vehicles 30a to 30f illustrated in FIG. 1 is an example and is not limiting. In the following description, the vehicles 30a to 30f are referred to simply as the vehicles 30 when not limiting specifically.

The vehicle 30 transmits battery information on the corresponding battery to a cloud server apparatus 50 using wireless communication or the like. The cloud server apparatus 50 is an information processing apparatus constructed in a cloud environment on a network such as the Internet. The battery information includes a state of health (SOH). The vehicle management apparatus 10 can be connected to the cloud server apparatus 50 using wireless communication or wired communication.

The vehicle management apparatus 10 generates a vehicle deployment plan in which assignment of the vehicles 30 to each of the districts is defined.

More specifically, the vehicle deployment plan is information in which the numbers of vehicles 30 assigned to the corresponding districts for a plan applicable period and the degradation states of the batteries mounted on the vehicles 30 thus assigned are defined. The degradation state of the battery mounted on each of the vehicles 30 is the SOH of each of the batteries mounted on the vehicles 30.

The vehicle management apparatus 10 also generates an operation plan in which delivery routes for the vehicles 30 in daily delivery service of the vehicles 30 are defined. The operation plan is information in which packages loaded on the individual vehicles 30, delivery destinations, and driving routes are defined.

In the present embodiment, when a plan applicable period for the vehicle deployment plan and a plan applicable period for the operation plan are described while being discriminated from each other, the plan applicable period for the vehicle deployment plan is referred to as a first plan applicable period, the plan applicable period for the operation plan is referred to as a second plan applicable period. In contrast, when the plan applicable period for the vehicle deployment plan and the plan applicable period for the operation plan are described without being discriminated from each other, either of these periods are simply referred to as a plan applicable period. The first plan applicable period is, for example, a period of a few months, six months, or the like in the future. The second plan applicable period is, for example, one day next to a day when the plan generation processing is executed.

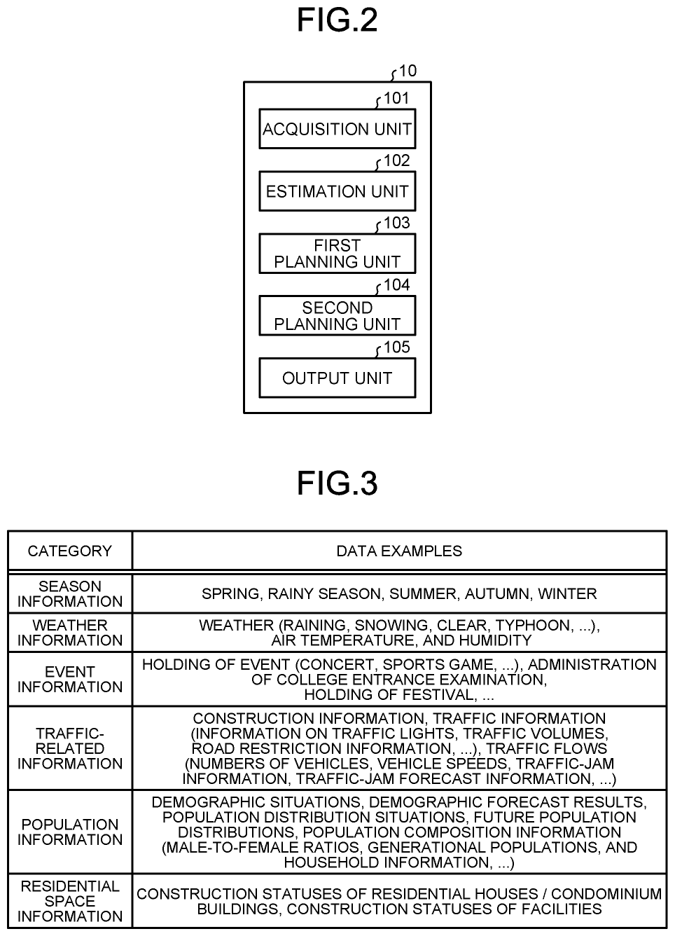

FIG. 2 is a view illustrating an example of functions of the vehicle management apparatus 10 according to the present embodiment. As illustrated in FIG. 2, an acquisition unit 101, an estimation unit 102, a first planning unit 103, a second planning unit 104, and an output unit 105 are included therein.

A computer program to be executed in the vehicle management apparatus 10 of the present embodiment is recorded in a computer-readable storage medium, such as a compact disc read-only memory (CD-ROM), a flexible disk (FD), a compact disc recordable (CD-R), or a digital versatile disk (DVD), in a file having an installable format or an executable format, to be provided.

Optionally, a computer program to be executed in the vehicle management apparatus 10 of the present embodiment may be stored on a computer connected to a network such as the Internet to be provided by being downloaded via the network. A computer program to be executed in the vehicle management apparatus 10 of the present embodiment may be provided or distributed via a network such as the Internet. A computer program to be executed in the vehicle management apparatus 10 of the present embodiment may be provided by being previously embedded in a read-only memory (ROM) or the like.

In an example, the CPU in the vehicle management apparatus 10 implements functions corresponding to the acquisition unit 101, the estimation unit 102, the first planning unit 103, the second planning unit 104, and the output unit 105 described above by reading out the computer program from the memory and executing it.

The acquisition unit 101 acquires the degradation states of the batteries mounted on the vehicles 30 and external variable factors concerning the districts in which the vehicles 30 are to travel. The acquisition unit 101 also acquires geographical information on these districts. The geographical information includes the extents of the districts, altitude differences, and residence locations in the districts.

The external variable factors differ from period to period; therefore, the acquisition unit 101 acquires the external variable factors that correspond to the plan applicable period for the vehicle deployment plan or the operation plan. When the estimation unit 102 described below performs processing for determining a time to change the vehicle deployment plan, the acquisition unit 101 acquires the external variable factors that correspond to a period that is longer than the plan applicable period of the vehicle deployment plan.

In the present embodiment, the degradation state of each battery is indicated by the SOH. In the present embodiment, the SOH is the proportion, expressed in a percentage, of the current full charge capacity (Ah) to the initial full charge capacity (Ah). The degree of degradation is lower when the value of the SOH is nearer to 100%. A manner in which to calculate the SOH is not limited to this example, and the SOH may be calculated using resistance values.

Manners in which to acquire the degradation state of each battery and the external variable factors are not particularly limited. For example, the acquisition unit 101 may acquire, via the cloud server apparatus 50, the value of the SOH calculated by a battery management unit (BMU) in the corresponding vehicle 30. The degradation states of the batteries and the external variable factors may be transmitted from another apparatus via a network. The degradation states of the batteries and the external variable factors may be manually input by a user to the input apparatus of the vehicle management apparatus 10.

Each of the external variable factors is information on an external environment surrounding the vehicle 30 and is a factor that affects at least one of, for example, the amount of packages in the corresponding district, a travel distance needed for the vehicle 30 to make delivery, and a travel time length needed for the vehicle 30 to make delivery. Examples of the external variable factor include season information that indicates a season that corresponds to the plan applicable period and traffic information in the districts that corresponds to the plan applicable period. The external variable factor is not limited to these examples.

In the present embodiment, “affecting a travel distance or a travel time length of the vehicle 30” means both “affecting a travel distance or a travel time length for which the vehicle 30 needs to travel for service such as delivery” and “affecting a travel distance or a travel time length for which the vehicle 30 can travel”.

FIG. 3 is a view illustrating an example of external variable factors according to the present embodiment. As illustrated in FIG. 3, the external variable factors may include a part or all of the season information, weather information, event information, the traffic information, population information, and residential space information.

The season information is a season that corresponds to the plan applicable period in the delivery target district, which is, for example, spring, summer, autumn, or winter in the case of Japan. Divisions of seasons are not limited to four seasons and may include, for example, a rainy season as illustrated in FIG. 3. Furthermore, instead of being treated as one season, summer may be divided into more detailed divisions such as “the summer holiday period” and “the Bon holiday period”. Likewise, winter may be divided into more detailed divisions such as “the winter holiday period” and “the New Year's holiday period”. The season information affects, for example, the amount of packages. Mid-summer gifts are delivered during summer, and year-end gifts are delivered during winter. Thus, the amount of packages may be higher than other periods depending on the district. The season information may also affect the travel distance or the travel time length. In the snowy region, the vehicle 30 travels with a reduced speed during winter. Thus, the travel time length may be longer than the other periods. Depending on the district, autumn is a period when the number of tourists increases, the travel time length may be extended due to occurrence of traffic jams, or the travel distance may be extended in order to bypass traffic jams.

The weather information is information on weather in the plan applicable period. For example, the weather information is information on weather, an air temperature, and humidity. The weather is, for example, raining, snowing, clear, or a typhoon. This information may be real-time information or may be weather forecast results for the plan applicable period. For example, as the external variable factor for generating the vehicle deployment plan for three months starting six months later, the acquisition unit 101 acquires the weather information for three months starting six months later. Optionally, as the external variable factor for generating the operation plan for a day next to the current day, the acquisition unit 101 may acquire a weather forecast result for that next day or the current weather information.

The event information is information on the period and the place of an event, to be held, where a large number of people gather. Examples of the event include holding of an event such as a concert or a sports game, administration of a college entrance examination, and holding of a festival. However, the event is not limited to these examples.

The traffic-related information is information on road traffics during the plan applicable period. Examples of the traffic information include construction information, traffic information, and traffic flows. The construction information is information on road construction locations and periods. The traffic information is information on traffic lights, traffic volumes, road restriction information, or the like. The traffic flow is information on the number of vehicles, the speeds of vehicles, traffic-jam information, traffic-jam forecast information, or the like.

The population information is information on the populations of the districts for the plan applicable period or at present. Examples of the population information include demographic situations, demographic forecast results, population distribution situations, future population distributions, and population composition information. Examples of the population composition information include male-to-female ratios, generational populations, and household information of the districts. The household information is, for example, the number of single-person households or the number of family households but may be more detailed information on the household composition.

The residential space information is the construction statuses of residential houses or condominium buildings, construction statuses of various facilities, or the like. The construction statuses are information including the locations of the planned building construction sites and the scheduled construction completion times of residential houses, condominium buildings, or various facilities.

The external variable factors illustrated in FIG. 3 are examples and are not limited thereto. The acquisition unit 101 may acquire some of the external variable factors illustrated in FIG. 3 instead of acquiring all of these external variable factors.

The acquisition unit 101 transmits, to the estimation unit 102 and the second planning unit 104, the acquired degradation states of the batteries, the acquired external variable factors, and the acquired geographical information on the individual districts.

When operation plan processing is generated, the amount of packages and delivery destinations for the second plan applicable period are already determined. The acquisition unit 101 therefore acquires information on the amount of packages and the delivery destinations for the second plan applicable period. The acquisition unit 101 transmits the acquired information on the amount of packages and the delivery destinations for the second plan applicable period to the second planning unit 104.

Based on the external variable factors acquired by the acquisition unit 101, the estimation unit 102 estimates travel distances and the numbers of travels in the individual districts for the plan applicable period. In the present embodiment, based on the external variable factors acquired by the acquisition unit 101, the estimation unit 102 also estimates the amount of packages and the numbers of delivery destinations for the individual districts for the plan applicable period.

For example, based on the external variable factors and the geographical information of the individual districts acquired by the acquisition unit 101, the estimation unit 102 estimates the amounts of packages and the numbers of delivery destinations for the individual districts for the plan applicable period. The estimation unit 102 further estimates the travel distances and the numbers of travels in the individual districts from the extents of the individual districts and the estimated amounts of packages and the estimated numbers of delivery destinations for the individual districts. For example, when the amount of packages per day is 100 while the amount of packages that can be loaded on one vehicle 30 is 10 for one of the districts, the corresponding number of travels is 10. At this point of time, it is not yet determined whether the delivery is made with one of the vehicles 30 traveling 30 times, is made in a shared manner with 10 of the vehicles 30 each traveling one time, or is made in another shared manner with another number of vehicles 30.

Information estimated by the estimation unit 102 is not limited to the travel distances and the numbers of travels. For example, based on the external variable factors acquired by the acquisition unit 101, the estimation unit 102 estimates, for each of the districts for the plan applicable period, at least one of the following: a travel distance, the number of travels, a delivery time length, and a power consumption of each of the vehicles 30. The delivery time length is a time length to be taken to complete the corresponding delivery.

For example, the estimation unit 102 may acquire slope information, traffic-light information, traffic-jam information, or the like from the map information that includes information on curves, slopes, or traffic lights of roads and estimate the consumed power of the vehicles 30 based on the information thus acquired. It is assumed that the map information that includes information on curves, slopes, or traffic lights of roads has been stored in, for example, the storage apparatus, such as an HHD, in the vehicle management apparatus 10.

Based on the distances of delivery paths, vehicle speeds, and the number of deliveries, the estimation unit 102 estimates the delivery time length. In the case of time specified delivery, the estimation unit 102 further estimates the delivery time length based on time specification.

Based on driving information on drivers and the map information, the estimation unit 102 estimates the probabilities of occurrence of accidents. Specifically, based on the driving information on drivers and information on accident-prone areas based on the map information, the estimation unit 102 estimates the probabilities of occurrence of accidents. The estimation unit 102 also estimates a power generation source (such as coal-fired power generation, nuclear power generation, or renewable energy) of power with which electric vehicles have been charged, and estimates emission amounts of carbon dioxide based on the power consumptions. The estimation unit 102 further estimates degrees of damage due to transported goods. As the degrees of damage herein, the size of an impact and a temperature change that exceeds a given range during transportation are listed. For example, the degrees of damage are used when a transportation environment such as a temperature, humidity, vibration is important as in a case where medicines or precision instruments are transported.

The estimation unit 102 transmits the estimation results to the first planning unit 103.

The estimation unit 102 estimates cycles of changes of the external variable factors in a period that is longer than the plan applicable period for the vehicle deployment plan, and, based on the estimated cycles of changes, specifies a recommended time to change the vehicle deployment plan. For example, when there are seasonal changes in amount of packages, travel distance, or travel time length for a certain one of the districts, the estimation unit 102 specifies, as a recommended time to change the vehicle deployment plan, switching vehicle deployment plans when the seasons change. The estimation unit 102 transmits, to the output unit 105, the specified time to change the vehicle deployment plan.

Referring back to FIG. 2, based on the degradation states of the batteries and the external variable factors acquired by the acquisition unit 101, the first planning unit 103 generates the vehicle deployment plan in which assignment of the vehicles 30 to the districts is defined. More specifically, the first planning unit 103 generates the vehicle deployment plan based on at least one kind of information selected from the degradation states of the batteries and the following kinds of information estimated by the estimation unit 102: travel distances; the numbers of travels; the delivery time lengths; and the power consumptions of the vehicles 30; the probabilities of occurrence of accidents thereof; the carbon dioxide emissions thereof; and the degrees of damage thereof due to transported goods. In the present embodiment, in an example, the first planning unit 103 generates the vehicle deployment plan based on the degradation states of the batteries as well as the travel distances and the numbers of travels that have been estimated by the estimation unit 102 from the external variable factors.

For example, as illustrated in FIG. 1, the SOHs of the batteries mounted on the vehicles 30 may be different from one another. When the SOHs are lower as the degradation of the battery advances, the charge capacity of the battery is smaller than the charge capacity before the degradation. For this reason, the vehicle 30 that has the battery with a low SOH installed therein can travel for a shorter travel distance and shorter travel time length at one time than the vehicle 30 that has the battery with a high SOH installed therein.

For example, in the example illustrated in FIG. 1, the district X has a smaller extent and has a higher number of residential houses, that is, potential delivery destinations, than the district Y. In addition, the district X is expected to have a larger amount of packages 4 than the district Y in the plan applicable period. In this case, the first planning unit 103 deploys a larger number of vehicles 30 in the district X than in the district Y. In this case, the travel distance and the travel time length of each of the vehicles 30 deployed in the district X are shorter, and the first planning unit 103 therefore assigns, to the district X, the vehicles 30 the SOHs of which are relatively low. At the same time, a smaller amount of packages 4 need to be delivered over long distances in the district Y, and the first planning unit 103 therefore assigns, to the district Y, the vehicles 30 the SOHs of which are relatively high.

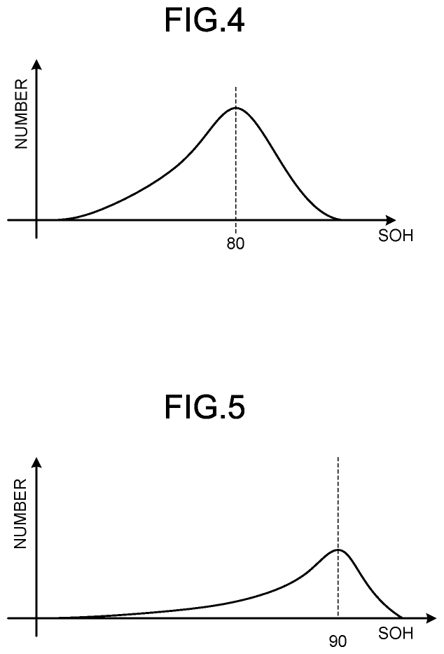

For example, FIG. 4 is a view illustrating an example of the relation between the number of vehicles 30 to be deployed in the district X and the corresponding SOHs, according to the present embodiment. In addition, FIG. 5 is a view illustrating an example of the relation between the number of vehicles 30 to be deployed in the district Y and the corresponding SOHs, according to the present embodiment. While the number of vehicles 30 for the district X is larger than that for the district Y, the SOH value that appears most frequently for the district X is lower than the SOH value that appears most frequently for the district Y. Here, the numbers of vehicles 30 and values of the SOHs illustrated in FIGS. 4 and 5 are examples and are not limiting.

In addition, because an electric vehicle needs a battery charging period, the first planning unit 103 generates the vehicle deployment plan with charging periods for batteries taken into account. A battery charging period is, for example, 8 hours, and the vehicle 30 in which power stored in the battery has become a threshold or less needs to wait for 8 hours before this vehicle 30 can be used for delivery next time.

The first planning unit 103 may change, in accordance with the SOHs of assignable vehicles 30, the number of travels estimated by the estimation unit 102. Furthermore, when there is a shortage in number of vehicles 30 that need to be assigned to any one of the districts, the first planning unit 103 specifies the number of vehicles 30 corresponding to the shortage and the SOH levels that these vehicles 30 need to have. For example, the first planning unit 103 specifies that “there is a shortage of two vehicles 30 that have the SOHs of 90% or higher”.

The first planning unit 103 transmits the generated vehicle deployment plan to the output unit 105.

When there is a shortage in number of vehicles 30, the first planning unit 103 additionally transmits the following to the output unit 105: the specified number of vehicles 30 corresponding to the shortage; and the specified SOH levels that these vehicles 30 need to have. Hereinbelow, information on the number of vehicles 30 corresponding to the shortage and the SOH levels that these vehicles 30 need to have, which is specified by the first planning unit 103, is referred to as vehicle shortage information.

Referring back to FIG. 2, the second planning unit 104 makes a plan as the operation plan of the vehicles 30 for a scheduled operation period with respect to each of the districts, based on the following information acquired by the acquisition unit 101: information on the amounts of packages and the delivery destinations; the external variable factor; and the degradation states of batteries mounted on the vehicles 30.

More specifically, the second planning unit 104 plans packages to be loaded on the individual vehicles 30, delivery destinations, and driving routes for the individual districts for the second plan applicable period, based on the following information acquired by the acquisition unit 101: the external variable factor; the degradation states of the batteries mounted on the vehicles 30; and information on the amount of packages and delivery destinations for the second plan applicable period. The second plan applicable period is, for example, one day next to the day on which the operation plan is generated.

In addition, as in the case of the first planning unit 103, the second planning unit 104 generates the operation plan with charging periods for the batteries in the vehicles 30 taken into account.

Here, “one day next to the day” is an example of the second plan applicable period, and the second plan applicable period may be one day that is the day on which the operation plan is generated or may be one week period next to the week in which the operation plan is generated. The second plan applicable period may be input by a user, for example, when the processing of generating the operation plan is executed, or may have been determined as a fixed period.

The second planning unit 104 transmits the generated operation plan to the output unit 105.

The output unit 105 displays the vehicle deployment plan, which has been generated by the first planning unit 103, on the display of the vehicle management apparatus 10. When the vehicle shortage information has been generated by the first planning unit 103, the output unit 105 additionally displays the vehicle shortage information on the display of the vehicle management apparatus 10. The output unit 105 also displays the operation plan, which has been generated by the second planning unit 104, on the display of the vehicle management apparatus 10. The output unit 105 also displays the time to change the vehicle deployment plan, which has been estimated by the estimation unit 102, on the display of the vehicle management apparatus 10.

Here, a form of output by the output unit 105 is not limited to display on the display. For example, the output unit 105 may transmit one of the following information to another information processing apparatus: the vehicle deployment plan; the operation plan; the vehicle shortage information; and the times to change the vehicle deployment plan.

The procedure of vehicle deployment plan processing that is executed in the vehicle management apparatus 10 configured as above according to the present embodiment is described next.

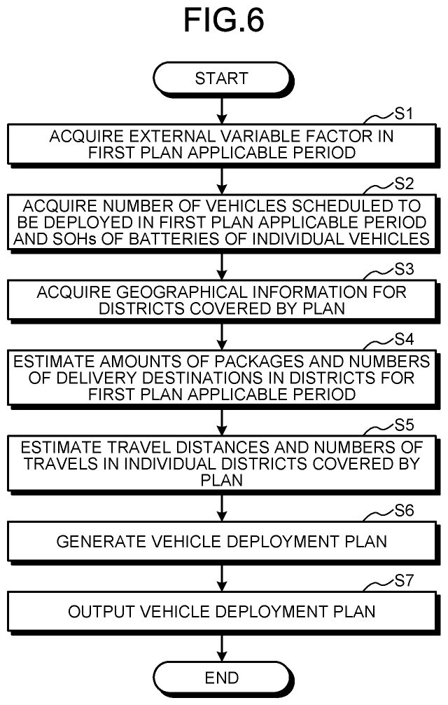

FIG. 6 is a flowchart illustrating an example of the procedure of the vehicle deployment plan processing that is executed in the vehicle management apparatus 10 according to the present embodiment.

It is assumed that the processing in this flowchart is performed after the estimation unit 102 determines the time to change the vehicle deployment plan. For example, this flowchart may be started when the first planning unit 103 has determined that the estimated time to change the vehicle deployment plan has arrived, or may be manually performed by a user in accordance with the estimated time to change the vehicle deployment plan.

Firstly, the acquisition unit 101 acquires the external variable factor in the first plan applicable period (S1). The acquisition unit 101 also acquires the number of vehicles 30 scheduled to be deployed in the first plan applicable period and the SOHs of the batteries of the individual vehicles 30 (S2).

The acquisition unit 101 also acquires the geographical information for districts covered by the plan (S3).

Subsequently, based on the external variable factors acquired by the acquisition unit 101, the estimation unit 102 estimates the amounts of packages and the numbers of delivery destinations for the districts for the first plan applicable period (S4).

Based on the extents of the districts and the amounts of packages and the numbers of delivery destinations estimated for the individual districts, the estimation unit 102 further estimates the travel distances and the numbers of travels for the individual districts covered by the plan (S5). The estimation unit 102 transmits, to the first planning unit 103, the estimated travel distances and the estimated numbers of travels.

Subsequently, based on the SOHs, acquired by the acquisition unit 101, of the batteries of the vehicles 30 as well as the travel distances and the numbers of travels estimated by the estimation unit 102, the first planning unit 103 generates the vehicle deployment plan in which assignment of the vehicles 30 to the districts covered by the plan is defined (S6). The first planning unit 103 transmits the generated vehicle deployment plan to the output unit 105.

Furthermore, upon determining that there is a shortage in number of vehicles 30 that need to be assigned to any one of the districts, the first planning unit 103 specifies the number of vehicles 30 corresponding to the shortage and the SOH levels that these vehicles 30 need to have, and transmits the vehicle shortage information to the output unit 105.

The output unit 105 outputs the vehicle deployment plan, which has been generated by the first planning unit 103, to the display (S7). When the vehicle shortage information has been generated by the first planning unit 103, the output unit 105 additionally outputs the vehicle shortage information on the display.

The procedure of the operation plan processing that is executed in the vehicle management apparatus 10 configured as above according to the present embodiment is described next.

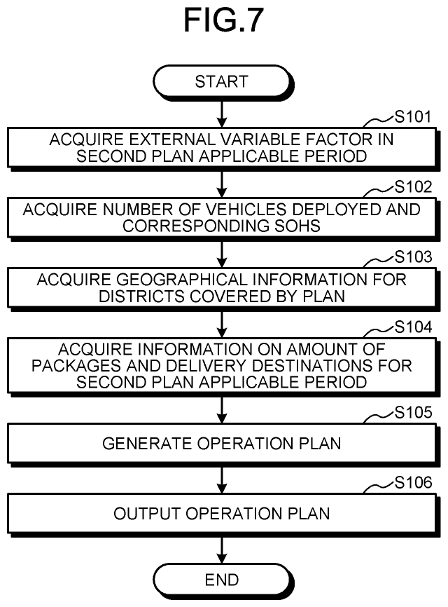

FIG. 7 is a flowchart illustrating an example of the procedure of operation plan processing that is executed in the vehicle management apparatus 10 according to the present embodiment.

Firstly, the acquisition unit 101 acquires the external variable factors corresponding to the second plan applicable period (S101).

The acquisition unit 101 also acquires the number of vehicles 30 deployed as of the time of execution of processing in this flowchart and the corresponding SOHs (S102). Here, when the vehicles 30 to be deployed in the second plan applicable period are scheduled to be different from the vehicles 30 deployed as of the time of execution of processing in this flowchart, the acquisition unit 101 acquires the SOHs for the vehicles 30 to be deployed in the second plan applicable period.

The acquisition unit 101 also acquires the geographical information for districts covered by the plan (S103).

The acquisition unit 101 also acquires information on the amount of packages and the delivery destinations for the second plan applicable period (S104). The acquisition unit 101 transmits the external variable factors, the geographical information, the information on the amount of packages and the delivery destinations, which have been acquired, to the second planning unit 104.

The second planning unit 104 generates the operation plan based on the following information acquired by the acquisition unit 101: the external variable factors; the number of vehicles 30 deployed; the SOHs of the batteries mounted on those vehicles 30; the geographical information; and information on the amount of packages and delivery destinations for the second plan applicable period (S105).

For example, based on the external variable factors, the amount of packages, the delivery destinations, and the geographical information, the second planning unit 104 calculates travel distances and the travel time lengths that are needed for delivery. The second planning unit 104 then specifies, based on the SOHs and the charging periods of the batteries mounted on the vehicles 30, distances, time lengths, and times (from when to when) for which the individual vehicles 30 can travel. The second planning unit 104 then assigns packages to the vehicles 30 that can deliver these packages to the delivery destinations thereof. The second planning unit 104 coordinates the correspondence between the vehicles 30 and the packages, and specifies combinations of the packages with the vehicles 30 so that all of the packages can be delivered to the delivery destinations thereof within a given delivery time length. The packages to be loaded on, the delivery destinations, and the driving routes to be assigned to the individual vehicles 30 are determined through specifying combinations of the packages, the delivery destinations, and the vehicles 30.

The second planning unit 104 transmits the generated operation plan to the output unit 105.

The output unit 105 then outputs the operation plan, which has been generated by the second planning unit 104, to the display (S106).

Thus, based on the degradation states of batteries mounted on the vehicles 30 and the external variable factors concerning the individual districts in which the vehicles 30 are to travel, the vehicle management apparatus 10 of the present embodiment generates the vehicle deployment plan in which assignment of the vehicles 30 to the districts has been defined. As a result, with the vehicle management apparatus 10 of the present embodiment, a highly precise vehicle deployment plan that reflects effects that the external variable factors and the degradation states of the batteries exert on the travel distances and the travel time lengths of the vehicles 30 can be generated.

The vehicle management apparatus 10 of the present embodiment generates the vehicle deployment plan based on the degradation states of a plurality of batteries mounted on a plurality of the vehicles 30 and the external variable factors concerning the individual districts in which the vehicles 30 are to travel. As a result, with the vehicle management apparatus 10 of the present embodiment, a highly precise vehicle deployment plan can be generated based on the degradation states of the individual batteries in the vehicles 30 covered by the deployment plan.

The external variable factor of the present embodiment is a season or traffic information for a plurality of districts for the first plan applicable period.

For example, conventionally, there have been cases where a vehicle deployment plan that does not fully reflect changes that occur to the amount of packages, the travel distances of electric vehicles, the travel time lengths thereof, or the like due to the external variable factors is generated. In those cases, for example, when a change has occurred to the amount of packages, the travel distances of electric vehicles, the travel time lengths thereof, or the like due to a season, traffic information, or the like, there may occur a situation where, while there is a shortage of delivery vehicles 30 in one district, there is an excess of delivery vehicles 30 in another district. In contrast, with the vehicle management apparatus 10 of the present embodiment, a vehicle deployment plan that enables the vehicles 30 to be efficiently operated can be generated through vehicle management that reflects the external variable factors, such as a season and traffic information, and the degradation states of batteries.

The vehicle management apparatus 10 of the present embodiment estimates cycles of changes of the external variable factors, and, based on the estimated cycles of changes, specifies a time to change the vehicle deployment plan. As a result, with the vehicle management apparatus 10 of the present embodiment, an appropriate time to change the vehicle deployment plan can be recommended even when a user does not know when each of the external variable factors that affect operation of the vehicles 30 changes.

The vehicle management apparatus 10 of the present embodiment plans the delivery routes of the vehicles 30 for a scheduled operation period for a plurality of districts based on information on the amounts of packages and delivery destinations for the second plan applicable period, the external variable factors, and the degradation states of batteries mounted on the vehicles 30. As a result, with the vehicle management apparatus 10 of the present embodiment, the vehicles 30 can be efficiently operated in daily delivery service.

In the present embodiment, the geographical information on each of the districts is described as information different from the external variable factors. However, the geographical information on each of the districts may be included among the external variable factors.

In the present embodiment, the vehicle management apparatus 10 is described as a PC, a server apparatus, or the like provided in the freight company 20. However, the vehicle management apparatus 10 is not limited thereto. For example, the cloud server apparatus 50 may be configured to include the function of the vehicle management apparatus 10. In this case, the cloud server apparatus 50 is an example of the vehicle management apparatus. The operation plan may be generated by information processing apparatuses, such as PCs, provided in the delivery stations 201a and 201b.

In the present embodiment, the first planning unit 103 and the second planning unit 104 are described as separate functions. However, a single planning unit may execute the processing of the first planning unit 103 and the second planning unit 104. Likewise, the first planning unit 103, the second planning unit 104, or a planning unit in which these units are incorporated may execute processing that is executed by the estimation unit 102 in the present embodiment.

In the present embodiment, the acquisition unit 101 is configured to acquire, in the vehicle deployment plan processing, the number of vehicles 30 scheduled to be deployed in the first plan applicable period and the SOHs for the vehicles 30. However, the acquisition unit 101 may acquire the number of currently deployed vehicles 30 and the SOHs for the vehicles 30. When this configuration is employed, for example, the first planning unit 103 may calculate the SOHs corresponding to the vehicles 30 for the first plan applicable period based on age deterioration of batteries from the present time to the first plan applicable period.

In the present embodiment, although the delivery routes of the vehicles 30 are described as being variable, the vehicles 30 may be base-to-base delivery cars that each shuttle between previously determined bases.

In the present embodiment, the vehicles 30 are delivery electric vehicles. However, the vehicles 30 are not limited thereto. For example, the vehicle 30 may be an electric motorcycle. For example, when the traffic information contains information indicating that a road is scheduled to be closed, the second planning unit 104 in the vehicle management apparatus 10 may assign an electric motorcycle to a delivery destination to which the road leads, so that the delivery destination can be reached via a narrow alley.

The vehicle 30 may be a vehicle for a public transportation system, such as an electric vehicle (EV) bus. In this case, the vehicle management apparatus 10 may be installed in a terminal of a public transportation system, a business office, a bus base, or the like.

The vehicle 30 may be a rental car, a vehicle for leasing, a company car, or the like that is used by a municipality or a company. In this case, the vehicle management apparatus 10 may be installed in a building of the municipal office or the like of a municipality or in a service office, a branch, a factory, an office, or the like of a company.

The vehicle 30 may be a taxi or an electric vehicle for ride sharing. In this case, the vehicle management apparatus 10 may be installed in an office or the like of a taxi company or a ride-sharing operator. The vehicle 30 may be a private electric vehicle owned by an individual. In this case, the vehicle management apparatus 10 may be a PC, a smartphone, or the like of the individual.

In the present embodiment, a case where the vehicle management apparatus 10 generates the vehicle deployment plan based on the SOHs of a plurality of batteries mounted on a plurality of the vehicles 30 has been described. However, the vehicle management apparatus 10 of the present embodiment can also be applied to a case where there is only one of the vehicles 30.

In the present embodiment, the SOHs of the batteries mounted on the vehicles 30 are configured to be calculated by the BMUs mounted on the vehicles 30. However, the SOHs may be calculated by the cloud server apparatus 50. For example, the cloud server apparatus 50 may calculate the SOHs from the battery information on the batteries, which has been acquired from the vehicles 30. When this configuration is employed, the battery information on the batteries, which is transmitted from the vehicles 30 to the cloud server apparatus 50, contains, for example, the current full charge capacities (Ah) of the batteries.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A vehicle management apparatus comprising:
a memory; and
a hardware processor coupled to the memory,
the hardware processor being configured to:
acquire a degradation state of a battery mounted on a vehicle, and an external variable factor concerning a plurality of districts in which the vehicle is to travel; and
generate, based on the degradation state of the battery and the external variable factor, a vehicle deployment plan in which assignment of the vehicle to the plurality of districts is defined.

2. The vehicle management apparatus according to claim 1, wherein the hardware processor is configured to:
acquire degradation states of a plurality of batteries mounted on a plurality of vehicles and the external variable factor concerning the plurality of districts in which the plurality of vehicles are to travel, and
generate the vehicle deployment plan, based on the degradation states of the plurality of batteries and the external variable factor.

3. The vehicle management apparatus according to claim 1, wherein
the hardware processor is further configured to estimate at least one of a travel distance, a number of travels, a delivery time length, and a power consumption of the vehicle, for each of the plurality of districts and for a first plan applicable period, based on the external variable factor, and
the hardware processor is configured to generate the vehicle deployment plan based on the degradation state of the battery and on the at least one of the travel distance, the number of travels, the delivery time length, and the power consumption of the vehicle.

4. The vehicle management apparatus according to claim 3, wherein
the vehicle is a delivery vehicle, and
the hardware processor is configured to estimate, based on the external variable factor, an amount of packages and a number of delivery destinations in each of the plurality of districts for the first plan applicable period, and estimate the travel distance and the number of travels in each of the plurality of districts, based on an extent of the district, and the estimated amount of packages and the estimated number of delivery destinations in the district.

5. The vehicle management apparatus according to claim 3, wherein the vehicle deployment plan is information in which a number of vehicles assigned to each of the plurality of districts for the first plan applicable period and degradation states of batteries mounted on the assigned vehicles are defined.

6. The vehicle management apparatus according to claim 3, wherein the external variable factor is a season in the first plan applicable period.

7. The vehicle management apparatus according to claim 3, wherein the external variable factor is traffic information of each of the plurality of districts.

8. The vehicle management apparatus according to claim 3, wherein the hardware processor is configured to estimate a cycle of change of the external variable factor, and specify a time to change the assignment of the vehicle to the plurality of districts, based on the estimated cycle of change.

9. The vehicle management apparatus according to claim 3, wherein
the vehicle is a package delivery vehicle,
the hardware processor is configured to:
acquire information on an amount of packages and a delivery destination in each of the plurality of districts for a second plan applicable period shorter than the first plan applicable period, and the external variable factor for the second plan applicable period, and
plan a delivery route of the vehicle for the second plan applicable period for each of the plurality of districts, based on the information on the amount of packages and the delivery destination for the second plan applicable period, the external variable factor, and the degradation state of the battery mounted on the vehicle.

10. A non-transitory computer-readable medium on which an executable program is recorded, the program instructing a computer to carry out:
acquiring a degradation state of a battery mounted on a vehicle, and an external variable factor concerning a plurality of districts in which the vehicle is to travel; and
generating, based on the degradation state of the battery and the external variable factor acquired at the acquiring, a vehicle deployment plan in which assignment of the vehicle to the plurality of districts is defined.
